(19) United States
(12) Patent Application Publication
(10) Pub. No.: US 2004/0213988 A1
(43) Pub. Date: Oct. 28, 2004

(54) Conductive film lamination

(75) Inventor: Timothy J. Skillman, Maineville, OH (US)

Correspondence Address: BROOKS KUSHMAN P.C., 1000 TOWN CENTER, TWENTY-SECOND FLOOR, SOUTHFIELD, MI, 48075, US

(73) Assignee: Equistar Chemicals, L.P., Houston, TX (US)

(21) Appl. No.: 10/422,493

(22) Filed: Apr. 24, 2003

(51) Int. Cl. B05D 1/04

(52) U.S. Cl. 428/327; 428/323; 427/458

(57) ABSTRACT

The present invention discloses a method of improving paint adhesion thermoplastic olefin parts. The method comprises attaching a conductive layer to a thermoplastic olefin substrate to form a coated thermoplastic substrate. After attachment of the conductive layer paint is applied to the side of the coated thermoplastic olefin substrate on which a surface of the conductive layer is exposed. In another embodiment of the present invention, a coated thermoplastic olefin substrate with improved paint adhesion is provided.

### BACKGROUND OF THE INVENTION

1. Field of the Invention

The present invention is related to methods of improving the paint transfer efficiency of electrostatically applied paints to a substrates form from thermoplastic olefins.

2. Background Art

The automotive industry and others produce parts from polyolefin materials by the injection molding process. Many of these parts are subsequently painted to achieve the desired finish. Polyolefins are non-polar thus an expensive surface treatment is required to obtain adequate paint adhesion to the polyolefin part. Typically, a chlorinated polyolefin is spray applied to the surface of the part prior to painting. A second problem resulting from the non-polar nature of the polyolefin part is very low paint transfer efficiencies in the electrostatic painting process.

One method to improve paint transfer efficiencies is to produce a part from a conductive polyolefin. Development of conductive injection molded polyolefin parts has been investigated by Dow, Solvay and others. Although a part requiring having good paint transfer efficiency can be produced from a conductive polyolefin, the resulting part has two major drawbacks. A part produced from a conductive polyolefin has very poor impact strength. The high concentration of conductive carbon black or nano-tubes required to achieve the desired conductivity adversely effects the impact strength. The second drawback is the cost of the part. Because the expensive conductive fillers are incorporated throughout the part, the part is too expensive to be economically viable.

Accordingly, there exists a need in the prior art for low cost polyolefin substrates with improved paintability and for methods of making these substrates.

### SUMMARY OF THE INVENTION

The present invention overcomes the problems encountered in the prior art by providing a method of improving paint transfer efficiencies to a thermoplastic olefin substrate. The method of the invention is a multi-step process comprising attaching an electrically conductive layer to the thermoplastic olefin substrate to form a coated thermoplastic substrate, and then electrostatically applying paint to a side of the coated thermoplastic olefin substrate on which a surface of the electrically conductive layer is exposed. Finally, forming a final article may be formed after the coated substrate is painted by any number of traditional plastic processing methods. Such an article will have good paint transfer efficiency in the electrostatic paint process.

In another embodiment of the present invention, a coated thermoplastic olefin substrate suitable for electrostatic painting is provided. The coated thermoplastic olefin substrate is the method set forth above.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

In one embodiment of the present invention, a method of improving paint transfer efficiency adhesion to a thermoplastic olefin substrate is provide. The method of the invention comprises attaching an electrically conductive layer to the thermoplastic olefin substrate to form a coated thermoplastic substrate and then electrostatically applying paint to a side of the coated thermoplastic olefin substrate on which a surface of the electrically conductive layer is exposed. The electrically conductive layer preferably comprises a thermoplastic polymer and an electrically conductive powder where the electrically conductive powder is dispersed within the thermoplastic polymer. Although any thermoplastic polymer may be used in practicing the invention, the preferred thermoplastic polymer is selected from the group consisting of polyolefins, polystyrenes, polyesters, polycarbonates, and mixtures thereof. More preferred thermoplastic polymers include acrylonitrile-butadiene-styrene copolymer, high-impact polystyrene, high-density polyethylene, high molecular weight polyethylene, polypropylene, polyvinyl chloride, polyethylene terephthalate modified with CHDM (1,4 cyclohexanedimethanol), and mixtures thereof. Most preferably, the thermoplastic polymer is a polyolefin. The electrically conductive powder may be any powder that is composed of electrically conducting particles. Preferably, the electrically conductive powder is selected from the group consisting of electrically conductive carbon black, electrically conductive carbon nano-tubes, carbon fibers, metallic powders, metallic fibers, ionic conductive polymers, intrinsically conductive polymeric powder (e.g., polypyrrole), semiconductor powders, doped semiconductor powders, and mixtures thereof. The preferred conductive powder is electrically conductive carbon black which is preferably present in an amount of about 10 weight % to about 60 weight % of the combined weight of the thermoplastic polymer and the conductive powder.

The method of the invention may be used to apply paint to objects of varying shape. For example, the thermoplastic olefin substrate may be essentially flat prior to the step of electrostatically applying paint or may have curvature prior to the step of electrostatically applying paint. Similarly, the thermoplastic olefin substrate is bent in a brake prior to the step of electrostatically applying paint.

The electrically conductive layer may be applied to the thermoplastic olefin substrate by a number of methods know to one skilled in the art. In some methods of applying a conductive layer, a conductive sheet (i.e., film) or shell will be used. Such conductive sheets or shells can be produced by a number of plastic forming operations which include, but are not limited to, cast extrusion, blown film extrusion, solvent casting or the like. Thin thermoformed shells from a conductive sheet can also be used in subsequent processing methods. These thin shells can be used in insert injection molding to form the electrically conductive layer of the present invention. A thin conductive shell (approx. 20-mil) conforming to the shape of the injection mold can be inserted into the injection mold and then another polyolefin is injected behind the shell to form the thermoplastic olefin substrate. The resulting injection molded part has a conductive surface ready to paint. The thin thermoformed shells could be utilized similarly in an insert blow molding or insert rotational molding process. Polyolefin sheet (suitable for the thermoplastic olefin substrate) produced by the sheet extrusion method is also readily available and can be produced from 10 mils to upwards of 500 mils in thickness. The thickness of the conductive sheet and the thickness of the polyolefin substrate will be determined by the final part thickness and processing method.

The thermoplastic substrate may be applied, for example, by pressure laminating an electrically conductive sheet to the thermoplastic olefin substrate. In such pressure laminating processes, the electrically conductive sheet optionally includes an adhesive on the side of the electrically conductive shell which contacts the thermoplastic olefin substrate. When an adhesive is used, the electrically conductive layer must be heated to a sufficient temperature to soften the adhesive layer.

Another method for producing a final article with a conductive surface is by thermoforming a thick sheet with a thin conductive cap layer. Suitable thermoforming processes include for example by vacuum forming, pressure forming, or twin sheet thermoforming processes. Vacuum forming is the most common and simplest thermoforming method. In this method the sheet of thermoplastic olefin substrate and the conductive layer are adhered to a mold typically using atmospheric pressure. In the twin forming method, the thermoplastic olefin substrate and the electrically conductive layer are simultaneously formed on two opposing half-molds. Each plastic half is then welded together under high pressure. The minimum thickness of the final part and the depth of draw determine the starting thickness of the conductive sheet layer and total sheet thickness. The conductive sheet thickness of the starting sheet will have to be adjusted to obtain an estimated minimum 3-mil thickness in the final thermoformed part. The thermoformed part can be trimmed, painted and used in an assembly to produce the final article.

The electrically conductive layer may also be adhered to the substrate by extruding the thermoplastic olefin substrate and then contacting an electrically conductive sheet to the thermoplastic olefin substrate while the thermoplastic substrate is at a sufficient temperature to adhere to the electrically conductive sheet. This is typically at the nip of the chill roll. Again, this extrusion process may optionally include an adhesive on a side of the electrically conductive sheet which contacts the thermoplastic substrate. In such circumstances, the electrically conductive sheet must be heated to a sufficient temperature to soften the adhesive layer. Finally, another example of a method for attaching the electrically conductive layer is by coextruding the electrically conductive layer and the thermoplastic olefin substrate together.

In another embodiment of the present invention, a coated thermoplastic olefin substrate suitable for electrostatic painting is provided. The coated thermoplastic olefin substrate made by the method set forth above. Specifically, the coated thermoplastic olefin comprises a thermoplastic olefin substrate and an electrically conductive layer disposed over the thermoplastic olefin substrate. The electrically conductive layer comprises a thermoplastic olefin polymer and an electrically conductive powder, the electrically conductive powder is dispersed within the thermoplastic polymer. Preferred choices for the components of this embodiment are the same as set forth above for the method of forming a coated thermoplastic substrate.

The following examples illustrate the various embodiments of the present invention. Those skilled in the art will recognize many variations that are within the spirit of the present invention and scope of the claims.

Conductive TPO Formulations

The formulations in table 1 are compounded together in a mixer. After compounding, these formulations are then coextruded as the combinations shown in Table 2. Sheet A-K are then vacuum formed over a male mold with the conductive TPO layer away from the mold surface. These vacuumed formed parts are then coated with ohm Haas HP21054-4B1 adhesion promoter. Next, the parts are electrostatically coated with PPG CBC 1K base coat and then PPG TKU2000B 2K clear coat

TABLE 1
Conductive TPO formulations.

| | Equistar | Equistar | | |
|---|---|---|---|---|
| | PD1022A | TP4390HU | Cabot Vulcan | Cabot Vulcan |
| | TPO | TPO | XC605 Carbon | XC305 Carbon |
| TPO A | 30% | | 70% | |
| TPO B | 30% | | | 70% |
| TPO C | 50% | | 50% | |
| TPO D | 50% | | | 50% |
| TPO E | | 30% | 70% | |
| TPO F | | 30% | | 70% |
| TPO G | | 50% | 50% | |
| TPO H | | 50% | | 50% |

Produce Multi-Layer Conductive TPO Sheet via Co-extrusion

TABLE 2
Multi-layer TPO sheet Structures via co-extrusion sheet processing.

| | |
|---|---|
| Sheet A | 165 mil Equistar PD951GRY TPO (“PD951GRY”) |
| | and 15 mil TPO A |
| Sheet B | 150 mil PD951GRY and 30 mil TPO A |
| Sheet C | 135 mil PD951GRY and 45 mil TPO A |
| Sheet D | 150 mil PD951GRY and 30 mil TPO B |
| Sheet E | 150 mil PD951GRY and 30 mil TPO C |
| Sheet F | 150 mil PD951GRY and 30 mil TPO D |
| Sheet G | 150 mil PD951GRY and 30 mil TPO E |
| Sheet H | 150 mil PD951GRY and 30 mil TPO F |
| Sheet I | 150 mil PD951GRY and 30 mil TPO G |
| Sheet J | 150 mil PD951GRY and 30 mil TPO H |
| Sheet K | 150 mil PD951GRY and 30 mil RTP Company ESD |
| | C 2800-50D TPO |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of improving paint transfer efficiency to a thermoplastic olefin substrate, the method comprising:
attaching an electrically conductive layer to the thermoplastic olefin substrate to form a coated thermoplastic substrate; and
electrostatically applying paint to a side of the coated thermoplastic olefin substrate on which a surface of the electrically conductive layer is exposed.

2. The method of claim 1 wherein the electrically conductive layer comprises a thermoplastic polymer and an electrically conductive powder, the electrically conductive powder dispersed within the thermoplastic polymer.

3. The method of claim 2 wherein:
the thermoplastic polymer is selected from the group consisting of polyolefins, polystyrenes, polycarbonates, and mixtures thereof; and
the electrically conductive powder is selected from the group consisting of electrically conductive carbon black, electrically conductive carbon nano-tubes, carbon fibers, metallic powders, metallic fibers, ionic conductive polymers, intrinsically conductive polymeric powder, semiconductor powders, doped semiconductor powders, and mixtures thereof.

4. The method of claim 3 wherein the thermoplastic olefin substrate is essentially flat prior to the step of electrostatically applying paint.

5. The method of claim 1 wherein the coated thermoplastic substrate is given curvature prior to the step of electrostatically applying paint.

6. The method of claim 5 wherein the coated thermoplastic substrate is bent in a brake prior to the step of electrostatically applying paint.

7. The method of claim 1 wherein the step of attaching the electrically conductive layer is by pressure laminating an electrically conductive sheet to the thermoplastic olefin substrate.

8. The method of claim 7 wherein the electrically conductive sheet includes an adhesive on a side of the electrically conductive shell which contacts the thermoplastic olefin substrate.

9. The method of claim 8 wherein the electrically conductive layer is heated to a sufficient temperature to soften the adhesive layer.

10. The method of claim 1 wherein the step of attaching the electrically conductive layer is by thermoforming the electrically conductive layer and the thermoplastic substrate together.

11. The method of claim 10 wherein the thermoforming is achieved by vacuum forming, pressure forming, or twin sheet thermoforming processes.

12. The method of claim 1 wherein the step of attaching the electrically conductive layer comprises:
extruding the thermoplastic substrate;
contacting an electrically conductive sheet to the thermoplastic substrate while the thermoplastic substrate is at a sufficient temperature to adhere to the electrically conductive sheet.

13. The method of claim 12 wherein the electrically conductive sheet includes an adhesive on a side of the electrically conductive sheet which contacts the thermoplastic substrate.

14. The method of claim 13 wherein the electrically conductive layer is heated to a sufficient temperature to soften the adhesive layer.

15. The method of claim 1 wherein the step of attaching the electrically conductive layer comprises coextruding the electrically conductive layer and the thermoplastic olefin substrate together.

15. The method of claim 1 wherein the step of attaching the electrically conductive layer comprises:
providing a shell made from an electrically conductive polymer, the shell conforming to the shape of an injection mold;
inserting the shell into the injection mold;
injecting into the injection mold a polyolefin to form the thermoplastic olefin substrate.

16. A coated thermoplastic olefin substrate for painting, the coated thermoplastic olefin comprising:
a thermoplastic olefin substrate; and
an electrically conductive layer disposed over the thermoplastic olefin substrate.

17. The coated thermoplastic olefin substrate of claim 16 wherein the electrically conductive layer comprises a thermoplastic polymer and an electrically conductive powder, the electrically conductive powder dispersed within the thermoplastic polymer.

18. The coated thermoplastic olefin substrate of claim 17 wherein:
the thermoplastic polymer is selected from the group consisting of polyolefins, and mixtures thereof; and
the electrically conductive powder is selected from the group consisting of electrically conductive carbon black, electrically conductive carbon nano-tubes, carbon fibers, metallic powders, metallic fibers, ionic conductive polymers, intrinsically conductive polymeric powder, semiconductor powders, doped semiconductor powders, and mixtures thereof.

19. The coated thermoplastic olefin substrate of claim 16 wherein the thermoplastic olefin substrate is essentially flat prior to the step of electrostatically applying paint.

20. The coated thermoplastic olefin substrate of claim 16 wherein the coated thermoplastic substrate is given curvature prior to the step of electrostatically applying paint.
